(19) United States
(12) Patent Application Publication
(10) Pub. No.: US 2003/0188317 A1
(43) Pub. Date: Oct. 2, 2003

(54) Advertisement system and methods for video-on-demand services

(76) Inventors: William J. Liew, Montville, NJ (US); Chunyan Tricia Liu, Montville, NJ (US)

Correspondence Address: Chunyan Tricia Liu, 12 Mountain Ave., Montville, NJ, 07045, US

(21) Appl. No.: 10/109,320

(22) Filed: Mar. 28, 2002

(51) Int. Cl. H04N 7/173

(52) U.S. Cl. 725/88

(57) ABSTRACT

An advertisement system and methods for video-on-demand (VOD) services. The invented system comprises means and steps of synchronizing and coordinating between advertisement play and VOD play so that the advertisement play will not be skipped by fast-forwarding of the VOD play to assure the viewing of advertisements by viewers.

### BACKGROUND OF THE INVENTION

This invention relates to an advertisement system and methods for video-on-demand (VOD) services, and particularly to the means and steps of synchronizing and coordinating between the invented advertisement system and a VOD system with fast-forward functions to assure viewing of advertisements by viewers.

VOD services are becoming more and more popular in US and other parts of the world. Currently there are two kinds of VOD technologies: Internet-protocol (IP) based VOD technologies and non-IP-based VOD technologies. The non-IP-based VOD technologies include VOD, near VOD (NVOD), digital VOD or analog VOD technologies.

It is well-known that most of conventional non-VOD TV services are supported by advertisement revenues. It is expected that some of the new VOD services also may be supported by advertisement revenues. For example, free TV news, sports, shows and movies with advertisement commercials may be offered over VOD services. Most of existing digital VOD players, including software players or hardware players, have the capability to play fast-forward for consumers' convenience. On the other hand, the fast-forward-play feature also allows viewers to be able to skip the advertisement commercials of any VOD programs in existing VOD systems. This would dramatically reduce the advertisement revenue for VOD service providers and content providers.

In U.S. Pat. No. 4,506,387 by Walter, a method is disclosed to make VOD services possible by downloading video files from a central data station to a data receiving station through a fiber optic line and broadcasting the video to a viewer according to his demand. No methods in Walter are disclosed to offer fast-forward, pause, backward functions for this kind of VOD services.

In U.S. Pat. No. 5,206,722 by Kwan assigned to AT&T Bell Laboratories (now Lucent Technologies Bell Labs), a method is disclosed to make VOD services possible over a conventional analog TV network by designating a number of analog channels (e.g., channel #611-#999) for VOD services. In this kind of VOD services, a viewer can choose to watch a video program at a specified time. No methods in Kwan are disclosed to offer fast-forward, pause, backward functions for this kind of VOD services.

In U.S. Pat. No. 5,508,732 by Bottomley et al assigned to IBM, U.S. Pat. No. 5,561,456 by Yu assigned to IBM, U.S. Pat. No. 5,583,937 by Ullrich et al assigned to GTE, and U.S. Pat. No. 5,682,597 by Ganek et al assigned to IBM, a method is disclosed to increase the throughput of a VOD system by allowing a number of viewers requesting for the same video program to wait for a tolerable length of time before being served by a single stream. The methods disclosed in Bottomley et al do not provide any fast-forward, pause, backward functions for this kind of VOD services.

In U.S. Pat. No. 5,357,276 by Banker et al assigned to Scientific-Atlanta, U.S. Pat. No. 5,517,257 by Dunn et al assigned to Microsoft, U.S. Pat. No. 5,606,359 by Youden, et al assigned to Hewlett-Packard Company, U.S. Pat. No. 5,720,037 by Biliris et al assigned to Lucent Technologies, U.S. Pat. No. 5,815,146 by Youden et al assigned to HP, U.S. Pat. No. 5,899,582 by DuLac assigned to Hyundai, methods are disclosed to provide the fast-forward and fast-reverse play capabilities for VOD or NVOD services. However, they do not provide any advertisement methods for the VOD/NVOD systems with the capabilities of preventing viewers from skipping commercial advertisements.

An object of this invention is to design a VOD system with fast-forward functions and the capability to assure advertisement commercials being viewed by the VOD viewers and prevent viewers from skipping the advertisement commercials.

Another object of this invention is to design an IP-based VOD system with the fast-forward, slow-forward, and backward functions and the capability to assure advertisement commercials being viewed by the VOD viewers and prevent viewers from skipping the advertisement commercials.

### SUMMARY OF THE INVENTION

The goal of this invention is to design a VOD system with fast-forward functions and the capability to assure advertisement commercials being viewed by the VOD viewers and prevent viewers from skipping the advertisement commercials.

The VOD system in one embodiment of this invention comprises at least one hardware server and a plurality of clients. Each hardware server comprises an advertisement server and a VOD server. Each Client comprises a playing unit, a VOD unit, an advertisement unit, a scheduling unit, and an optional storage unit. The clients are connected to the hardware server through IP connections.

In one embodiment of the invention, the hardware server is a general-purpose computer hardware server, such as an IBM hardware server or a Dell hardware server both running a Linux operating system. The hardware server could also be an application-specific hardware server particularly designed for VOD services. In one embodiment of the invention, both the advertisement server and the VOD server are a suite of software programs running in the hardware server. The advertisement server and the VOD server may also reside in different hardware servers.

The client is a hardware personnel computer (PC), a set-top-box connected to a TV set, or a wireless device. The playing unit, VOD unit, advertisement unit, scheduling unit and optional storage unit in the client are interconnected to each other and are communicating to the advertisement server and the VOD server in the hardware server.

The VOD server, the client's VOD unit and scheduling unit together provide VOD functions for the client, including but not limited to ordering movies/TV programs, downloading movies to client using a TCP or UDP protocol, scheduling a VOD play, collecting billing information and transporting the billing information to a billing server.

The advertisement server, the client's advertisement unit and scheduling unit together provide advertisement functions for the client, including but not limited to downloading advertisement files using a TCP or UDP protocol, scheduling and coordinating the advertisement play/VOD play, collecting advertisement play information and reporting the advertisement play information to a billing server.

When a VOD play is scheduled to start, a VOD file is played either offline from the storage unit, or played real-time when the VOD file is being downloaded from the file server. When an advertisement play is scheduled by the advertisement server and the scheduling unit, the regular VOD play is interrupted and paused and the advertisement file is played on the client's screen. The advertisement play is preferably uninterruptible to assure the advertisement being viewed by viewers. After the advertisement play ends, the regular VOD play starts again from the point where the VOD play was paused.

In one embodiment of the invention, the fast forward VOD play is implemented by storing the VOD files in the storage unit and dropping some of the VOD frames when the file is being played. The slow forward VOD play is implemented by repeating each VOD frame by a given number of times when the file is being played. The fast backward VOD play is implemented by playing the VOD frames in a backward fashion and dropping some of the VOD frames when the file is being played.

Since the advertisement files are different than the VOD files and the advertisement play is controlled separately than the VOD play, the fast-forward play of the VOD files cannot skip the advertisement play. The advertisement and VOD method disclosed in this invention assure the advertisement being viewed by viewers and allow service providers to generate advertisement revenues.

### BRIEF DESCRIPTION OF THE DRAWINGS

FIG. 1 is a schematic diagram illustrating one embodiment of the advertisement system and methods for VOD services with fast-forward functions.

FIG. 2 illustrates a logic flow chart of the software program in the client implementing the advertisement function for the VOD services.

### DETAILED DESCRIPTION

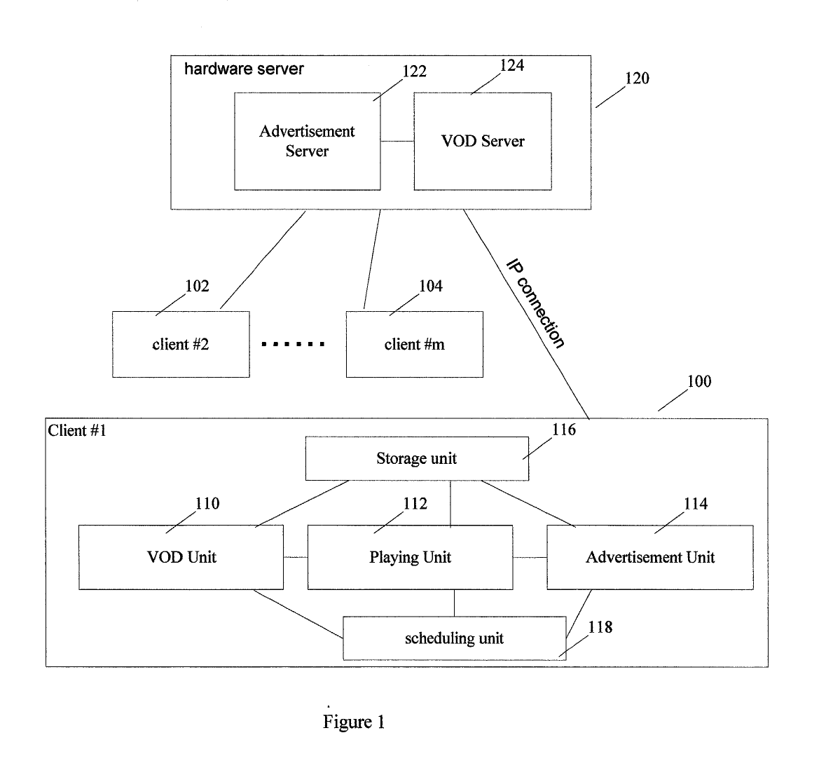

Referring to FIG. 1, VOD system in one embodiment of this invention comprises at least one hardware server 120 and a plurality of clients 100, 102, 104, et al. Each hardware server 120 comprises an advertisement server 122 and a VOD server 124. Each Client 100 comprises a playing unit 112, a VOD unit 110, an advertisement unit 114, a scheduling unit 118, and an optional storage unit 116. The clients 100, 102, 104 are connected to the hardware server 120 through IP connections.

In one embodiment of the invention, the hardware server 120 is a general-purpose computer hardware server, such as an IBM hardware server or a Dell hardware server both running a Linux operating system. The hardware server 120 could also be an application-specific hardware server particularly designed for VOD services. In one embodiment of the invention, both the advertisement server 122 and the VOD server 124 are a suite of software programs running in the hardware server 120. The advertisement server 122 and the VOD server 124 may also reside in different hardware servers.

The client 100 is a hardware personnel computer (PC), a set-top-box (STB) connected to a TV set, or a wireless device. The playing unit 112, VOD unit 110, advertisement unit 114, scheduling unit 118 and optional storage unit 116 in the client are interconnected to each other and are communicating to the advertisement server 122 and the VOD server 124 in the hardware server 120. The playing unit 112, VOD unit 110, advertisement unit 114, scheduling unit 118 may be implemented by using software only, or by using a combination of software and hardware chips. For PCs and STBs, the storage unit 116 is generally included to provide better VOD services. For wireless and personnel-digital-assistance (PDA) devices, the optional storage unit 116 may not be included due to power-consumption, size and cost reasons.

The VOD server 124, the client's VOD unit 110 and scheduling unit 118 together provide VOD functions for the client 100, including but not limited to ordering movies/TV programs, downloading movies to client using a TCP or UDP protocol, scheduling a VOD play, collecting billing information and transporting the billing information to a billing server. A typical process of the VOD function is as follows. When a client logs into the VOD system after passing authentication, he is able to search for any one of the movies/TV programs. When he decides to order a movie/TV program, he clicks this movie/TV program and a message is sent to the VOD server 124. Then the VOD file for the movie/TV program is downloaded from the VOD server 124 to the client 100. If the storage unit 116 is available, the VOD file is stored in the storage unit 116 while it is being downloaded and played. If the storage unit 116 is not available for wireless or PDA devices, the VOD file is played in real-time while it is being downloaded.

The advertisement server 122, the client's advertisement unit 114 and scheduling unit 118 together provide advertisement functions for the client 100, including but not limited to downloading advertisement files using a TCP or UDP protocol, scheduling and coordinating the advertisement play/VOD play, collecting advertisement play information and reporting the advertisement play information to a billing server.

In one embodiment of the invention, the coordination of the VOD play and the advertisement play is implemented as follows. When a VOD play is scheduled to start, a VOD file is played either offline from the storage unit 116, or played real-time when the VOD file is being downloaded from the VOD server 124. When an advertisement play is scheduled by the advertisement server 122 and the scheduling unit 118, the regular VOD play is interrupted and paused and the advertisement file is played on the client's screen. The advertisement play is preferably uninterruptible to assure the advertisement being viewed by viewers. After the advertisement play ends, the regular VOD play starts again from the point where the VOD play was paused.

In one embodiment of the invention, the fast forward VOD play is implemented by storing the VOD files in the storage unit 116 and dropping some of the VOD frames when the file is being played. The slow forward VOD play is implemented by repeating each VOD frame by a given number of times when the file is being played. The fast backward VOD play is implemented by playing the VOD frames in a backward fashion and dropping some of the VOD frames when the file is being played.

Since the advertisement files are different than the VOD files and the advertisement play is controlled separately than the VOD play, the fast-forward play of the VOD files cannot skip the advertisement play. In addition, the client can only control the VOD play and cannot control the advertisement play. The advertisement and VOD method disclosed in this invention assures the advertisement being viewed by viewers and allow service providers to generate advertisement revenues.

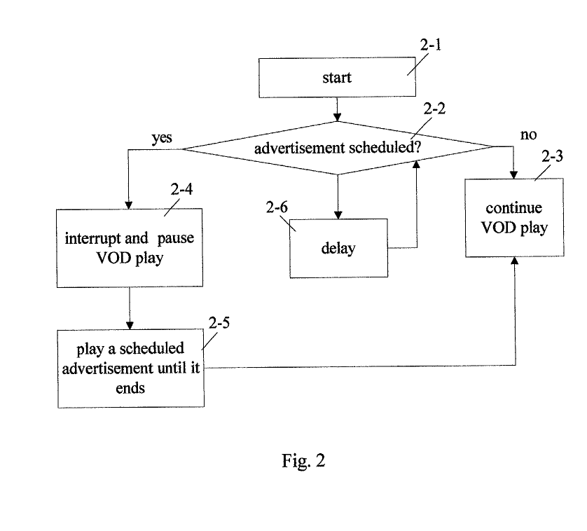

FIG. 2 illustrates a logic flow chart of a software program residing inside the client 100 coordinating the VOD play and the advertisement play. At the initial step 2-1 the software program starts and then proceeds to step 2-2. Then at step 2-2 it is checked if an advertisement is scheduled. If the advertisement is not scheduled, the VOD play continues at step 2-3. If the advertisement is scheduled, the program goes to step 2-4 to interrupt and pause the VOD play, then goes to step 2-5 to play a scheduled advertisement until the end of the advertisement play, and then goes to step 2-3 to continue the VOD play. As a parallel process, no matter what the decision result is at step 2-2, the program goes to step 2-6 to incur a delay and goes back to step 2-2 to check if a new advertisement is scheduled.

The steps 2-2 to 2-6 in FIG. 2 implement the advertisement functions coupled to the VOD play function. With the software program disclosed in this invention, the advertisement commercials cannot be skipped by viewers using the fast-forward play since the advertisement function is separated from the VOD function and cannot be controlled by the client.

While considerable emphasis has been herein on the preferred embodiment illustrated and described hereinabove, it will be appreciated that other embodiments of the invention can be made and that changes can be made in the preferred embodiment without departing from the principals of the present invention. Accordingly, it is to be distinctly understood that the foregoing descriptive matter is to be interpreted merely as illustrative of the invention and not as a limitation.

What is claimed is:

1. A VOD system comprising:
at least one advertisement server;
at least one VOD server;
a plurality of clients connecting to said advertisement server and said VOD server with each of said clients comprising:
a playing unit which plays VOD files or advertisement files and generates a VOD play or an advertisement play,
a VOD unit communicating with said VOD server,
an advertisement unit communicating with said advertisement server,
a scheduling unit which schedules said VOD play and said advertisement play according to scheduling commands from said advertisement server or said VOD server.

2. The VOD system as defined in claim 1 wherein:
said VOD play is controlled separately than said advertisement play and said advertisement play cannot be controlled by said client.

3. The VOD system as defined in claim 1 wherein:
said advertisement unit interrupts and pauses said VOD play and starts said advertisement play according said scheduling commands;
said advertisement unit resumes said VOD play after said advertisement play ends from a point where said VOD play was paused.

4. The VOD system as defined in claim 2 wherein:
said advertisement play cannot be interrupted or paused or stopped by any external commands other than said scheduling commands.

5. The VOD system as defined in claim 1 wherein:
said client further comprises a storage unit;
advertisement files and VOD files from said storage unit are input into said playing unit for said advertisement play and said VOD play.

6. The VOD system as defined in claim 1 wherein:
said client implements a fast forward play function by dropping a given number of video frames during said VOD play,

7. The VOD system as defined in claim 1 wherein:
said client implements a slow forward play function by repeating video frames by a given number of times during said VOD play.

8. The VOD system as defined in claim 1 wherein:
said client implements a fast backward play function by dropping a given number of video frames and playing video frames in a backward fashion during said VOD play.

9. The VOD system as defined in claim 1 wherein:
said client implements a slow backward play function by repeating video frames by a given number of times and playing video frames in a backward fashion during said VOD play.

10. The VOD system as defined in claim 5 wherein:
said fast forward play can be interrupted and paused by said advertisement play according to said scheduling commands.

11. The VOD system as defined in claim 1 wherein:
each of said clients comprises a software program implementing a process comprising the steps of:
(11-1) starting said software program and then proceeding to step 11-2,
(11-2) checking if said advertisement play is scheduled, and proceeding to step 11-3 if said advertisement play is not scheduled, and proceeding to step 11-4 if said advertisement play is scheduled, and proceeding to step 11-6 if said advertisement play is scheduled or not scheduled,
(11-3) continuing said VOD play,
(11-4) interrupting and pausing said VOD play and proceeding to step 11-5,
(11-5) playing said advertisement play until said advertisement play ends, and proceeding to step 11-3,
(11-6) after a given delay, proceeding back to step 11-2.
